(19) United States
(12) Patent Application Publication
(10) Pub. No.: US 2007/0110029 A1
(43) Pub. Date: May 17, 2007

(54) Method for linking communication channels of disparate access technologies in a selective call unit

(75) Inventors: Edward L. Gilmore II, Sunrise, FL (US); Moises De La Cruz, Miami, FL (US); Luis A. Pichardo, Miramar, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/271,026

(22) Filed: Nov. 12, 2005

(51) Int. Cl. H04L 12/66

(52) U.S. Cl. 370/352

(57) ABSTRACT

An apparatus and method (200) are disclosed for linking communication channels of disparate access technologies in a selective call unit (SCU) (100). A system that incorporates teachings of the present disclosure may include, for example, an SCU having a multimode transceiver (102) supporting two or more disparate access technologies, and a controller (112) for managing operations thereof. The controller is programmed to establish (202) a first communication link on a select one of the access technologies, establish (204, 210) a second communication link on another one of the access technologies, and associate (208, 212) the first and second communication links.

### FIELD OF THE DISCLOSURE

The present disclosure relates generally to cross connecting communication channels, and more specifically to a method for linking communication channels of disparate access technologies in a selective call unit (SCU).

### BACKGROUND

End users with multimode communication devices such as a cellular phone with dispatch service (such as the Motorola i850) can communicate with third parties on either access technology, but not concurrently on both technologies. Consequently, an end user with a multimode communication device cannot engage in a three-way party conference with one party carrying a dispatch radio, and another carrying a cellular phone.

### SUMMARY OF THE DISCLOSURE

Embodiments in accordance with the disclosure provide a method for linking communication channels of disparate access technologies in an SCU.

In a first embodiment of the present disclosure, an SCU has a multimode transceiver supporting a two or more disparate access technologies, and a controller for managing operations thereof. The controller is programmed to establish a first communication link on a select one of the access technologies, establish a second communication link on another one of the access technologies, and associate the first and second communication links.

In a second embodiment of the present disclosure, a computer-readable storage medium operates in the SCU. The storage medium has computer instructions for establishing a first voice communication channel on a select one of a plurality of disparate access technologies, establishing a second voice communication channel on another one of the access technologies, and linking the first and second voice communication channels in response to a signal generated by an end user of the SCU.

In a third embodiment of the present disclosure, the SCU operates according to a method that links first and second communication channels operating in corresponding access technologies with disparate signaling protocols.

### BRIEF DESCRIPTION OF THE DRAWINGS

FIG. 1 is a block diagram of a selective call unit (SCU) according to teachings of the present disclosure;

FIG. 2 depicts a flowchart of a method operating in the SCU according to teachings of the present disclosure; and

FIG. 3 is a diagrammatic representation of a machine in the form of a computer system within which a set of instructions, when executed, may cause the machine to perform any one or more of the methodologies discussed herein.

### DETAILED DESCRIPTION

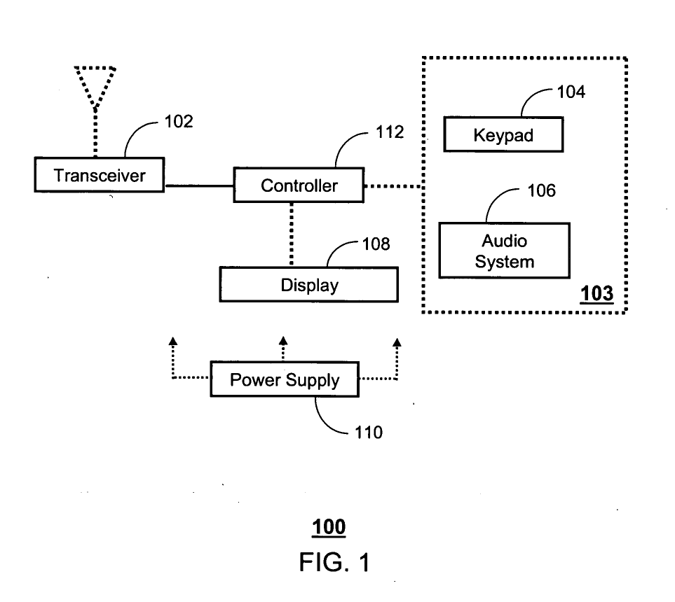

FIG. 1 is a block diagram of a selective call unit (SCU) 100 according to teachings of the present disclosure. The SCU 100 can have a multimode transceiver 102, an input interface 103, a display 108, a power supply 110, and a controller 112. The multimode transceiver 102 can utilize wireless or wireline technology for communicating with a communication system with two or more disparate access technologies. In the case of wireless communications, the transceiver 102 can operate in any number of communication systems that support, for example, two-way full-duplex voice and data communications such as with cellular technology (CDMA 1X, EV/DO, GSM, GPRS, Edge), WiFi, WiMax, and Bluetooth™.

Additionally, the multimode transceiver 102 can support two-way half-duplex voice technologies such as dispatch radio services operating under licensed frequencies, or Family Radio Services (FRS) operating under public frequencies. In the case of wireline communications, the multimode transceiver 102 can include technology that supports, for example, POTS (Plain Old Telephone Service), ISDN, Ethernet, Voice over IP (VoIP), and so on.

The input interface 103 can be an electro-mechanical interface such as a keypad 104 for selectively controlling operations of the SCU 100 with depressible keys and a navigation disk. Alternatively, or in addition to the keypad 104, the input interface 103 can comprise an audio system 106 that utilizes common technology for intercepting audio signals from an end user of the SCU 100 as well as for conveying audible signals thereto. The display 108 can utilize common display technology such as a liquid crystal display (LCD) for conveying text and graphical images to the end user of the SCU 100.

The power supply 110 can be portable or fixed. In the former embodiment, the power supply 110 can include one or more rechargeable batteries integrally coupled to the components of the SCU 100 for powering said components. The batteries can be recharged by common charging technology upon depleting the stored energy. In the latter embodiment, the power supply 110 processes a power signal supplied by a utility company, or from a central office much like power supplies in cordless phones.

The controller 112 manages operations of the aforementioned components of the SCU 100. The controller 112 can, for example, include one or more computing devices such as a microprocessor and a digital signal processor (DSP) with associated volatile and non-volatile memories (e.g., Flash, RAM, DRAM, etc.). Accordingly, the SCU 100 as just described can provide an end user means for communicating with others by way of a communication system (not shown). Communications can be over a circuit-switched network, packet-switched network (such as over the Internet using VoIP over a data channel), or combinations thereof.

According to the foregoing embodiments, the SCU 100 can represent a multimode portable and/or fixed communication device (e.g., cell phone with dispatch service, or a VoIP handset) capable of operating in two or more wireline and/or wireless communication systems.

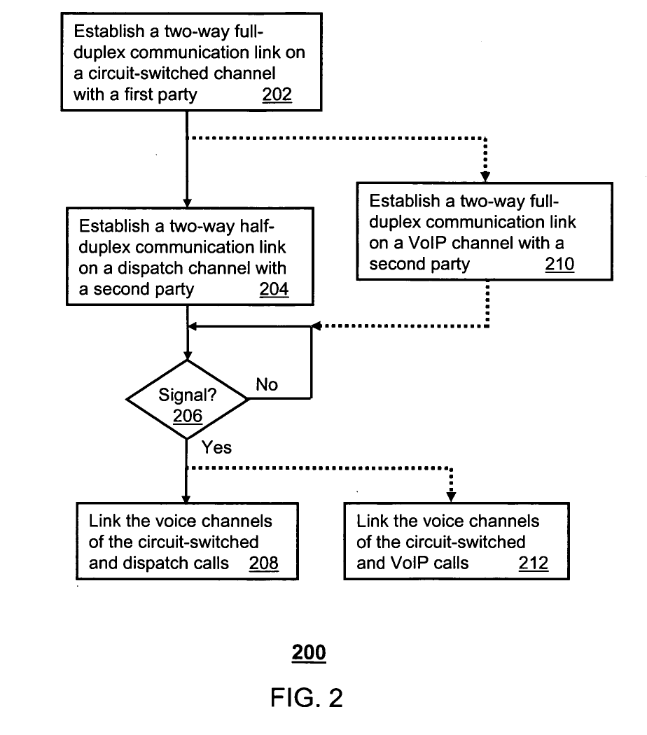

FIG. 2 depicts a flowchart of a method 200 operating in the SCU 100 according to teachings of the present disclosure. In a first embodiment, method 200 assumes the SCU 100 operates as a mobile multimode device with a transceiver 102 capable of two-way full-duplex communications (e.g., CDMA), and two-way half-duplex communications (e.g., common dispatch radio services).

With this in mind, method 200 begins with step 202 where the controller 112 establishes a two-way full-duplex communication link on a circuit-switched channel of a communication system (herein referred to by way of example as a CDMA network) with a first party communication device in response to the end user of the SCU 100, for example, dialing a phone number on the keypad 104. Alternatively, this step can represent a mobile terminated call accepted by the end user of the SCU 100 in response to a call originated by the first party. In either case, the two-way full-duplex communication link operates on a circuit-switched channel of the CDMA network, thereby providing the end user and the first party a means to exchange simultaneous voice messages by way of the audio system 106.

In step 204, the controller 112 establishes a two-way half-duplex communication link on a dispatch channel with a second party. This step can be invoked by the end user of the SCU 100 who desires to conference the second party with the first party even though both parties have disparate access technologies (i.e., dispatch half-duplex voice services with the second party, and full-duplex circuit-switched voice services with the first party). The end user of the SCU 100 in this step can place the first party on hold while attempting to make a dispatch call on the dispatch service mode of the SCU 100 by way of, for example, a push-to-talk (PTT) button of the keypad 104.

Once the second party has been contacted, the end user can conference the second party with the first party by depressing continuously the PTT button of the keypad 104 to initiate a conference signal that is detected by the controller 112 in step 206. In response to this signal, the controller 112 proceeds to step 208 where it links the voice channels of the circuit-switched and dispatch calls, thereby connecting the second caller to the communication already established between the end user and the first caller. This step can be accomplished by the controller 112 by linking voice channels in the protocols stacks of each access technology operating in the SCU 100 without assistance from infrastructure equipment of a communication system supporting circuit-switched and dispatch services. Alternatively, the PTT signal can be detected by infrastructure equipment of the communication system, and in response thereto perform linking of voice channels of each of the circuit-switched and dispatch access technologies.

Once the linking process is completed, the second caller can listen to what is said between the first caller and the end user. Similarly, the second caller can submit voice responses which can be heard by the end user and/or the first caller after the second party depresses the PTT button of his dispatch radio much like he would during a normal dispatch call. The embodiment of steps 202-208 demonstrates a means for conferencing parties utilizing disparate access technologies.

Steps 210-212 demonstrate yet another embodiment of method 200 for conferencing three parties with disparate access technologies. In this embodiment, the controller 112 begins with step 202 as described above and proceeds to step 210 where it establishes a two-way full-duplex communication link on a VoIP channel with a second party. The VoIP connection can be established by way of a data channel of the SCU 100 (e.g., EV/DO channel or 1X channel in a CDMA phone, or GPRS in a GSM phone). The voice channel can operate on a packet-switched real-time transport protocol (RTP) commonly used for supporting VoIP services.

This step can represent a use case in which the second party utilizes, for example, a fixed or portable VoIP handset. Once connected to the second party, the end user of the SCU 100 can conference the first and second parties by selecting a function of the keypad 104 (e.g., depressing the send button for a mobile device, or conference on a VoIP handset). The signal generated by the keypad 104 is detected in step 206 by the controller 112, and in step 212, the controller 112 connects the VoIP voice channel to the circuit-switched voice channel. Since VoIP is a full-duplex service, the end user need not depress any functions of the keypad 104 to maintain the conference. Similarly, the second party need not perform any functions on the VoIP handset to submit voice responses.

From these examples it should be evident to an artisan with ordinary skill in the art that there are innumerable ways to conference multiple parties utilizing disparate access technologies according to the present disclosure. For example, the foregoing embodiments can be modified so that the end user of the SCU 100 generates the signal of step 206 by way of a voice command rather than a selected function of the keypad 104. The first embodiment in which the second party utilizes dispatch services can also be modified so that instead of the end user depressing the PTT button continuously, the PTT button is depressed once to invoke a conference call, and the second party is the only one required to use the PTT button to transmit voice signals. Thus, when the second party does not depress the PTT of his dispatch radio he listens to the conversation from the first and/or the end user. When he intends to respond, he depresses the PTT button to begin conversation.

In yet another embodiment, the dispatch services of step 204 can be replaced with FRS services to accomplish the same result described earlier. Moreover, the aforementioned embodiments can be supplemented so that more than three-party conferences are possible. This can be accomplished by two or more of the parties in conference adding more parties by way of SCUs 100 capable of processing calls according to the aforementioned embodiments of method 200. More than three party conferences are also possible by way of service providers who offer SCU 100 users two or more lines of communication, in which case said users can each conference more than one party. From these illustrations, it would be evident to an artisan with ordinary skill in the art that the disclosed and undisclosed embodiments can best be understood from a reading of the claims described below.

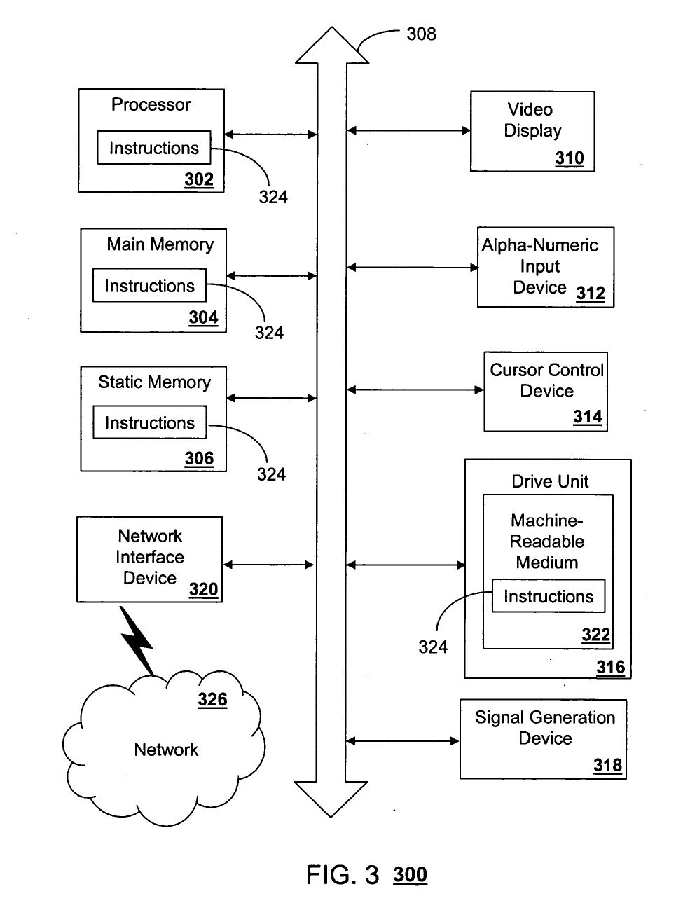

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A selective call unit (SCU), comprising:
a multimode transceiver supporting a plurality of disparate access technologies; and
a controller for managing operations of the multimode transceiver, wherein the controller is programmed to:
establish a first communication link on a select one of the access technologies;
establish a second communication link on another one of the access technologies; and
associate the first and second communication links.

2. The SCU of claim 1, wherein the multimode transceiver comprises at least one among a wireless transceiver and a wireline transceiver.

3. The SCU of claim 1, wherein the access technologies are at least two among a group of access technologies comprising two-way half-duplex dispatch communications, two-way full-duplex communications, and Voice over IP (VoIP) services.

4. The SCU of claim 1, wherein the multimode transceiver supports two-way half-duplex dispatch communications and two-way full-duplex communications, and wherein the controller is programmed to:
establish the first communication link using two-way full-duplex communications; and
establish the second communication link using two-way half-duplex communications.

5. The SCU of claim 1, comprising an input interface for controller operations of the SCU, and wherein the controller is programmed to associate in the SCU the first communication link to the second communication link in response to a signal received at the input interface.

6. The SCU of claim 5, wherein the input interface comprises at least one among a keypad and an audio system, and wherein the controller is programmed to process the signal generated by a manipulation of the keypad by an end user of the SCU, or by the signal generated by a voice command intercepted by the audio system.

7. The SCU of claim 1, comprising an input interface for controller operations of the SCU, and wherein the controller is programmed to associate at a communication system supporting the disparate access technologies the first communication link to the second communication link in response to a signal received at the input interface.

8. A computer-readable storage medium operating in a selective call unit (SCU), comprising computer instructions for:
establishing a first voice communication channel on a select one of a plurality of disparate access technologies;
establishing a second voice communication channel on another one of the access technologies; and
linking the first and second voice communication channels in response to a signal generated by an end user of the SCU.

9. The storage medium of claim 8, comprising computer instructions for establishing the first and second voice communication channels over at least one among a wireless communication medium and a wireline communication medium.

10. The storage medium of claim 8, comprising computer instructions for establishing the first and second voice communication channels over at least two among a group of access technologies comprising two-way half-duplex dispatch communications, two-way full-duplex communications, and Voice over IP (VoIP) services.

11. The storage medium of claim 8, wherein the storage medium comprises computer instructions for:
establishing the first voice communication channel using two-way full-duplex communications;
establishing the second voice communication channel using two-way half-duplex communications; and
linking the first and second communication channels in response to a signal generated by an input interface.

12. The storage medium of claim 8, comprising computer instructions for linking the first and second voice communication channels in response to a signal generated by an end user manipulating a keypad of the SCU.

13. The storage medium of claim 8, comprising computer instructions for linking the first and second voice communication channels in response to a signal generated by an audio system responsive to a voice command of an end user of the SCU.

14. In a selective call unit (SCU), a method comprising linking first and second communication channels operating in corresponding access technologies with disparate signaling protocols.

15. The method of claim 14, wherein the first and second communication channels operate as two-way half-duplex dispatch communications, and two-way full-duplex communications, respectively.

16. The method of claim 14, comprising linking the first and second communication channels in response to a signal generated by an end user of the SCU.

17. The method of claim 14, comprising establishing the first and second communication channels as voice channels over at least one among a wireless communication medium and a wireline communication medium.

18. The method of claim 14, comprising establishing the first and second communication channels over at least two among a group of access technologies comprising two-way half-duplex dispatch communications, two-way full-duplex communications, and Voice over IP (VoIP) services.

19. The method of claim 14, comprising linking the first and second communication channels in response to a signal generated by an end user manipulating a keypad of the SCU.

20. The method of claim 14, comprising linking the first and second communication channels in response to a signal generated by an audio system responsive to a voice command of an end user of the SCU.
